(19) United States
(12) Patent Application Publication
(10) Pub. No.: US 2026/0188051 A1
(43) Pub. Date: Jul. 2, 2026

(54) DEEPFAKE RESISTANT RANDOMIZED SYNCHRONIZED ACTION AUDIO OR VIDEO CAPTCHA FOR ONLINE PRESENCE AND LIVENESS VERIFICATION

(71) Applicants: Constructor Technology AG, Schaffhausen (CH); Constructor Education and Research Genossenschaft, Schaffhausen (CH)

(72) Inventors: Rasilia Rakhmatulina, Belgrade (RS); Andrey Adaschik, Istanbul (TR); Sergey Ulasen, Singapore (SG); Serg Bell, Singapore (SG); Stanislav Protasov, Singapore (SG); Nikolay Dobrovolskiy, Alanya (TR); Laurent Dedenis, Geneve (CH)

(21) Appl. No.: 19/531,759

(22) Filed: Feb. 6, 2026

Related U.S. Application Data
(63) Continuation-in-part of application No. 19/034,694, filed on Jan. 23, 2025.
(63) Continuation-in-part of application No. 19/004,064, filed on Dec. 27, 2024, now Pat. No. 12,531,002.

(51) Int. Cl. G06V 40/40; G06T 7/20; G06T 7/70; G06V 10/764; G06V 20/52; G06V 40/20; G06V 40/60

(52) U.S. Cl. CPC G06V 40/40; G06T 7/20; G06T 7/70; G06V 10/764; G06V 20/52; G06V 40/28; G06V 40/63

(57) ABSTRACT

Aspects of the present disclosure include a method for verifying live user presence in an online session. The method comprises providing, for presentation, a time-varying pattern and an instruction to a user to perform one or more requested user actions in synchrony with the pattern. The method further comprises receiving one or more data streams of the user during the presentation, extracting from the data streams feature information indicative of one or more detected user actions in the data streams, and generating one or more event signals based on the feature information. The method further comprises determining, based on the event signals and the pattern, a first measurement and a second measurement indicative of spatial correspondence and temporal alignment, respectively, between the detected user actions and the pattern, and verifying whether the user is a live person based on the first and second measurements.

### CROSS-REFERENCE TO RELATED APPLICATIONS

This application is a continuation-in-part of and claims the benefit of priority to both U.S. patent application Ser. No. 19/034,694, filed on Jan. 23, 2025 and entitled “PROCTORING OF ONLINE EXAMINATIONS USING GAZE DETERMINATION,” and U.S. patent application Ser. No. 19/004,064, filed on Dec. 27, 2024 and entitled “SYSTEMS AND METHODS FOR DETECTION OF THE PRESENCE OF A PERSON IN FRONT OF A DISPLAY WITH A CAMERA,” the contents of which are incorporated by reference herein in the entirety.

### FIELD OF TECHNOLOGY

The present disclosure relates to the field of online presence and liveness verification, and, more specifically, to systems and methods for verifying live user presence in an online session utilizing deepfake resistant synchronized action audio and/or or video CAPTCHAs (Completely Automated Public Turing test to tell Computers and Humans Apart).

### BACKGROUND

A CAPTCHA (Completely Automated Public Turing test to tell Computers and Humans Apart) is used to determine if an online user is really a human and not a bot. Users often encounter CAPTCHAs on the Internet.

A deepfake is an artificial image or video.

Examinations are now commonly taken on computers, offering convenience and accessibility for both learners and institutions. These computer examinations are conducted through specialized software or platforms that allow learners to take tests from remote locations. They often include features like automated proctoring, time tracking, and instant grading. However, this shift to computer examinations has also introduced new opportunities for cheating. Learners might use unauthorized resources such as notes, search engines, or communication tools like messaging apps during the exam. Other learners may simply have someone else pretend to be the learner and take the computer examination for the learner under the learner's login credentials. In other cases, in examinations with video proctoring, a pre-recorded video loop or a deepfake of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. Therefore, there is a need to strengthen online presence and liveness verification during online sessions (e.g., remote exams or remote proctoring) against deepfakes, prerecorded video, and remote helpers

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

One aspect of the present disclosure includes a method for verifying live user presence in an online session. The method comprises providing, for presentation, a time-varying pattern and an instruction to a user to perform one or more requested user actions in synchrony with the pattern. The method further comprises receiving one or more data streams of the user during the presentation, extracting from the data streams feature information indicative of one or more detected user actions in the data streams, and generating one or more event signals based on the feature information. The method further comprises determining, based on the event signals and the pattern, a first measurement and a second measurement indicative of spatial correspondence and temporal alignment, respectively, between the detected user actions and the pattern, and verifying whether the user is a live person based on the first and second measurements.

Another aspect of the present disclosure includes a system for verifying live user presence in an online session. The system comprises one or more memories configured to store executable instructions, and one or more processors communicatively coupled with the one or more memories. The one or more processors are configured, individually or in any combination, to execute the executable instructions to provide, for presentation, a time-varying pattern and an instruction to a user to perform one or more requested user actions in synchrony with the pattern. The one or more processors are further configured, individually or in any combination, to execute the executable instructions to receive one or more data streams of the user during the presentation, extract from the data streams feature information indicative of one or more detected user actions in the data streams, and generate one or more event signals based on the feature information. The one or more processors are further configured, individually or in any combination, to execute the executable instructions to determine, based on the event signals and the pattern, a first measurement and a second measurement indicative of spatial correspondence and temporal alignment, respectively, between the detected user actions and the pattern, and verify whether the user is a live person based on the first and second measurements.

Another aspect of the present disclosure includes a non-transitory computer-readable medium having instructions for verifying live user presence in an online session. The instructions are executable by one or more processors, individually or in any combination, to provide, for presentation, a time-varying pattern and an instruction to a user to perform one or more requested user actions in synchrony with the pattern. The instructions are further executable by the one or more processors, individually or in any combination, to receive one or more data streams of the user during the presentation, extract from the data streams feature information indicative of one or more detected user actions in the data streams, and generate one or more event signals based on the feature information. The instructions are further executable by the one or more processors, individually or in any combination, to execute the executable instructions to determine, based on the event signals and the pattern, a first measurement and a second measurement indicative of spatial correspondence and temporal alignment, respectively, between the detected user actions and the pattern, and verify whether the user is a live person based on the first and second measurements.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of an example environment for verifying live user presence in an online session, according to some aspects of the present disclosure;

FIG. 2 is a block diagram of an example tracking module, according to some aspects of the present disclosure;

FIG. 3 is a block diagram of an example synchrony evaluation module, according to some aspects of the present disclosure;

FIG. 4A is a first example synchronized action challenge, according to some aspects of the present disclosure;

FIG. 4B is a second example synchronized action challenge, according to some aspects of the present disclosure;

FIG. 4C is a third example synchronized action challenge, according to some aspects of the present disclosure;

FIG. 4D is a fourth example synchronized action challenge, according to some aspects of the present disclosure;

FIG. 4E is an example workflow for tracking user actions of the user in response to the fourth example synchronized action challenge;

FIG. 5 is flow diagram of an example method for verifying live user presence in an online session, according to some aspects of the present disclosure; and

FIG. 6 presents an example of a general-purpose computer system on which aspects of the present disclosure can be implemented.

### DETAILED DESCRIPTION

Aspects of the disclosure improve online presence and liveness verification during online sessions (e.g., remote exams or remote proctoring) against deepfakes, prerecorded video, and remote helpers. Aspects of the disclosure periodically issue random, interactive video and/or audio CAPTCHA (Completely Automated Public Turing test to tell Computers and Humans Apart) challenges in which a user is instructed to perform a specific physical or spoken action in synchrony with a time varying pattern displayed and/or played on a device, tracks the user's motion and/or speech, and evaluates both spatial correctness of the action and precise temporal alignment with the pattern. As real-time deepfake and avatar systems introduce latency and have difficulty reproducing arbitrary, high frequency, tightly synchronized motion, mismatches in this comparison indicate spoofing or cheating, while consistent alignment confirms a live user actively following the instructions. Aspects of the disclosure provide a robust, hard to spoof liveness and user identity check during online sessions by combining randomized action prompts with strict temporal pattern following requirements.

Exemplary aspects are described herein in the context of a system, a method, and a non-transitory computer-readable medium for verifying live user presence in an online session. Aspects of the present disclosure include providing, for presentation, a time-varying pattern and an instruction to a user to perform one or more requested user actions in synchrony with the pattern, receiving one or more data streams of the user during the presentation, extracting from the data streams feature information indicative of one or more detected user actions in the data streams, generating one or more event signals based on the feature information, determining, based on the event signals and the pattern, a first measurement and a second measurement indicative of spatial correspondence and temporal alignment, respectively, between the detected user actions and the pattern, and verifying whether the user is a live person based on the first and second measurements.

In one aspect, each user action comprises at least one of a physical action or a speech action.

In one aspect, the pattern comprises at least one of a time-varying visual cue presented via a display or a time-varying audio cue presented via one or more audio speakers.

In one aspect, the data streams comprise at least one of a video data stream or an audio data stream.

In one aspect, at least one body region of the user corresponding to a physical action is detected in one or more individual video frames of the video data stream, and a position or an orientation of the at least one body region is tracked over time, where the feature information comprises a motion time series of the position, the orientation, or a derivative thereof.

In one aspect, at least one utterance spoken by the user is detected in one or more individual audio frames of the audio data stream, where the feature information comprises an audio motion time series of the at least one utterance.

In one aspect, the verifying comprises determining whether the first and second measurements satisfy pre-determined criteria, and determining the detected user actions are suspicious in response to determining the first and second measurements do not satisfy the pre-determined criteria.

In one aspect, the verifying comprises classifying, using a machine learning model, the detected user actions as valid or suspicious.

In one aspect, an action type is randomly selected from a plurality of different action types, and the pattern is generated based on the selected action type. The plurality of different action types comprise at least one of a head movement, a hand movement, a finger movement, an eyebrow movement, or a reading of one or more words and/or one or more numbers.

In one aspect, at least one of the providing, the receiving, the extracting, the generating, the determining, or the verifying is repeated for different time-varying patterns and different instructions during the online session, and an overall trust score for the user is determined based on an aggregate of each measurement determined.

In one aspect, the instruction is presented via at least one of a display or one or more audio speakers.

In one aspect, the instruction further requires the user to move at least one of a physical object or at least one hand of the user across a virtual line positioned between a camera capturing a video data stream of the user and a face or a body region of the user.

In one aspect, the data streams comprise at least one of a first video data stream captured by a first camera, a second video data stream captured by a second camera, or a sensor data stream captured by a sensor. The first camera and the second camera are positioned at different positions relative to the user.

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

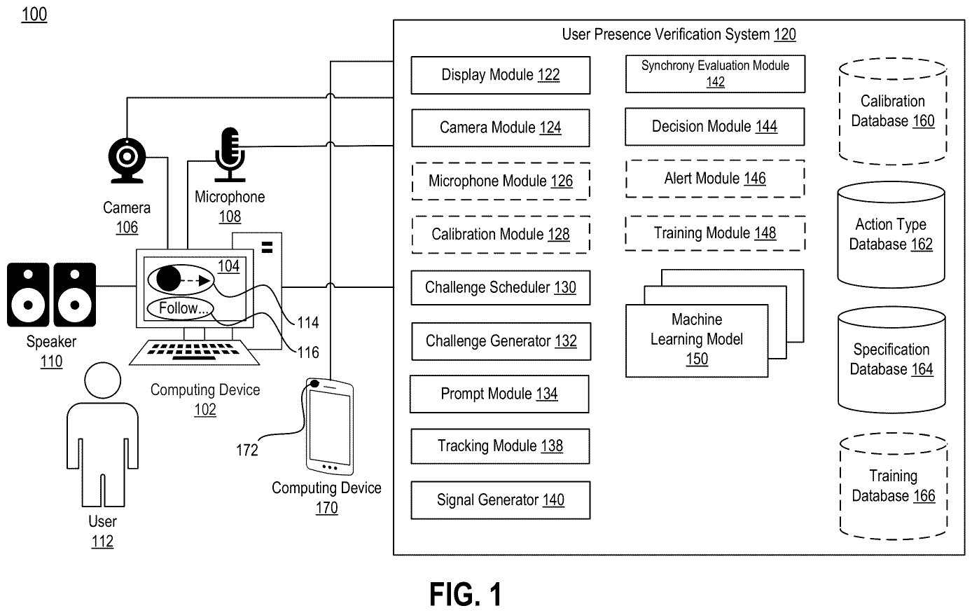

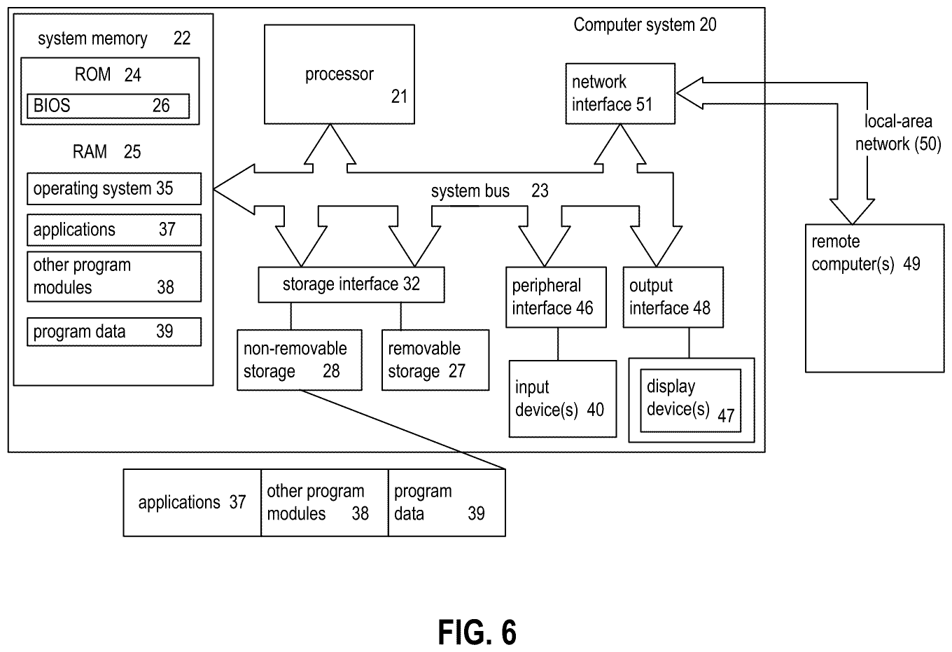

FIG. 1 is a block diagram of an example environment 100 for verifying live user presence in an online session, according to some aspects of the present disclosure. In some aspects, the environment 100 includes a computing device 102. In some aspects, the computing device 102 in FIG. 1 is implemented as a computer system 20 in FIG. 6. Examples of a computing device 102 include, but are not limited to, a mobile phone, a smart phone, a laptop, a tablet computer, a personal digital assistant, a wearable device (e.g., a smart watch, a head-mounted display, smart glasses, etc.), a desktop computer, a gaming console, an Internet of Things (IoT) device, and/or other computerized devices.

The computing device 102 executes a user presence verification system 120, which may be a standalone online presence and liveness verification software or a software component providing one or more online presence and liveness verification tools. The computing device 102 allows a user 112 to participate in an online session administered and/or proctored by the user presence verification system 120. As described in detail later herein, the user presence verification system 120 leverages advanced computer vision and/or machine learning techniques to verify live presence of the user during the online session. In one non-limiting example aspect, the online session comprises an online examination administered and proctored by the user presence verification system 120.

In some aspects, the environment 100 includes an electronic display 104 for displaying on-screen content. The display 104 is coupled to, or integrated in, the computing device 102. In one non-limiting example aspect, the display 104 is positioned in front of the user 112. The user presence verification system 120 can provide one or more visual cues for presentation (i.e., display) to the user 112 via the display 104 during an online session administered and/or proctored by the user presence verification system 120.

In some aspects, the environment 100 includes a camera 106 for capturing a video data stream. In one aspect, the camera 106 is coupled to, or integrated in, the computing device 102. In another aspect, the camera 106 is coupled to the user presence verification system 120. The user presence verification system 120 can obtain one or more video data streams captured via the camera 106. In one non-limiting example aspect, the camera 106 is positioned within proximity of the user 112 (e.g., in the same room as the user 112) and captures a video data stream of the user 112 during an online session administered and/or proctored by the user presence verification system 120.

In some aspects, the environment 100 includes a microphone 108 for capturing an audio data stream. In one aspect, the microphone 108 is coupled to, or integrated in, the computing device 102. In one aspect, the microphone 108 is integrated in, or implemented as part of, the camera 106. In another aspect, the microphone 108 is coupled to the user presence verification system 120. The user presence verification system 120 can obtain one or more audio data streams captured via the microphone 108. In one non-limiting example aspect, the microphone 108 is positioned within proximity of the user 112 (e.g., in the same room as the user 112) and captures an audio data stream of the user 112 during an online session administered and/or proctored by the user presence verification system 120.

In some aspects, the environment 100 includes one or more audio speakers 110 for audio playback. In one aspect, the one or more audio speakers 110 are coupled to, or integrated in, the computing device 102. In another aspect, the one or more audio speakers 110 are coupled to the user presence verification system 120. In one non-limiting example aspect, the one or more audio speakers 110 are positioned within proximity of the user 112 (e.g., in the same room as the user 112). The user presence verification system 120 can provide one or more audio cues for presentation (i.e., audio playback) to the user 112 via the one or more audio speakers 110 during an online session administered and/or proctored by the user presence verification system 120.

In some aspects, the environment 100 includes a second camera 172 for capturing a video data stream. In one aspect, the second camera 172 is coupled to, or integrated in, the computing device 102. In another aspect, the second camera 172 is coupled to, or integrated in, a different computing device 170 (e.g., a smart phone). In another aspect, the second camera 172 is coupled to the user presence verification system 120. The user presence verification system 120 can obtain one or more video data streams captured via the second camera 172. In one non-limiting example aspect, the first camera 106 and the second camera 172 are positioned at different positions relative to the user 112 (e.g., the first camera 106 is positioned in front of the user 112, and the second camera 172 is positioned to a side of the user 112), such that the cameras 106 and 172 capture video data streams of the user 112 from different perspectives (i.e., the different positions) during an online session administered and/or proctored by the user presence verification system 120. In some aspects, the first camera 106 and the second camera 172 are designated as a main camera and a secondary camera, respectively.

In some aspects, the environment 100 includes one or more sensors such as, but not limited to, the first camera 106, the microphone 108, the second camera 172, a GPS (not shown), a motion sensor (not shown), a temperature sensor (not shown), etc. The user presence verification system 120 is configured to receive one or more sensor data streams from the one or more sensors (e.g., video data streams from the cameras 106 and 172, audio data stream from the microphone 108, etc.).

The user presence verification system 120 includes a plurality of modules which the computing device 102 can execute. In some aspects, the user presence verification system 120 can be implemented in the computing device 102 or a cloud network (not shown) that is configured to execute the plurality of modules that together make up the user presence verification system 120.

In some aspects, the user presence verification system 120 includes a display module 122 configured to initialize an online session with the user 112, such as an online examination administered and proctored by the user presence verification system 120. The display module 122 is configured to generate one or more graphical user interfaces (GUIs), where each GUI includes content for presentation on the display 104 during the online session.

In some aspects, the user presence verification system 120 includes a camera module 124 configured for video acquisition. Specifically, the camera module 124 is configured to: (1) trigger the camera 106 and/or camera 172 to capture continuous video data stream(s) of the user 112 during the online session, and (2) obtain the video data stream(s) of the user 112.

In some aspects, the user presence verification system 120 optionally includes a microphone module 126 configured for audio acquisition. Specifically, the microphone module 126 is configured to: (1) trigger the microphone 108 to capture a continuous audio data stream of the user 112 during the online session, and (2) obtain the audio data stream of the user 112.

In some aspects, the user presence verification system 120 optionally includes a calibration module 128 configured to perform a calibration process (e.g., at the start of the online session). The calibration process includes identifying and parameterizing a pose and/or one or more body regions (i.e., body parts) of the user 112 based on video data stream(s) of the user 112 (e.g., via the camera 106), and establishing one or more reference geometries between the user 112 and the display 104. Examples of body regions include, but are not limited to, head, face, eyebrows, hands, arms, torso, etc.

In some aspects, the calibration process ensures that a field of view (FOV) for monitoring the user 112 is appropriately set up, i.e., the user 112 is correctly framed in the FOV of the camera 106. The calibration process is critical to validate the integrity of an environment of the user 112 during the online (e.g., an examination-taking environment if the online session comprises an online examination). In some aspects, calibration data relating to the user 112 (e.g., the pose and/or the one or more body regions of the user 112, the one or more reference geometries, etc.) can be stored in an optional database 160 (e.g., calibration database).

In some aspects, the user presence verification system 120 includes a challenge scheduler 130 and a challenge generator 132. The challenge scheduler 130 is configured to monitor the progress of the online session and determine when to initiate or run one or more challenges in which a live presence of the user 112 is verified (i.e., liveness checks). Each challenge is a synchronized action challenge in which the user 112 must perform one or more user actions in synchrony with one or more randomized audio and/or video CAPTCHAs.

In some aspects, the challenge scheduler 130 selects and schedules one or more times to initiate or run one or more challenges. The one or more times are selected in a random or pseudo-random manner, such that the user 112 and/or a potential third-party attacker cannot predict when the one or more challenges will occur. The challenge scheduler 130 is configured to trigger a start of a challenge by signaling the challenge generator 132 to generate a new synchronized action challenge. A start of a challenge is triggered when a time scheduled to initiate or run the challenge is reached or the user presence verification system 120 detects (via one or more other modules of the system 120) one or more suspicious circumstances relating to the live presence of the user 112.

In some aspects, to generate a new synchronized action challenge, the challenge generator 132 is configured to generate a time-varying pattern and an instruction to the user 112 to perform one or more requested user actions in synchrony with the pattern. Each pattern represents an audio and/or video CAPTCHA (Completely Automated Public Turing test to tell Computers and Humans Apart). Specifically, the challenge generator 132 randomly selects a user action type (that the user 112 will be requested to perform) from a predefined set maintained in a database 162 (e.g., action type database). Examples of user action types include, but are not limited to, nodding or shaking the head, raising a hand, moving a finger left and/or right, raising or furrowing eyebrows, rocking the upper body, reading a sequence of digits, virtual writing (or air writing), etc. Virtual writing (or air writing) comprises the user 112 raising a hand and writing or drawing in the air using an index finger or another finger of the hand, such as writing in the air a particular letter, digit, or word, drawing in the air a particular symbol, shape, or other object, or moving the finger in the air to draw, trace, or follow a curve, motion path, outline, or shape of a visual cue included in a time-varying pattern.

For the selected user action type, the challenge generator 132 generates a corresponding time-varying pattern and a corresponding instruction to the user 112 that is based on the pattern.

In some aspects, each time-varying pattern is a temporal, and optionally spatial, pattern including one or more audio and/or visual cues. Examples of audio and/or visual cues include, but are not limited to, a moving visual object following a motion path (presented via the display 104), a flashing visual object (e.g., segment or symbol) that changes state at discrete time instants (presented via the display 104), a rhythmic audio beat (presented via the one or more audio speakers 110), a sequence of digits (presented via the display 104) to be read aloud, a combination of one or more audio cues and one or more visual cues, etc.

For example, if a time-varying pattern presented to the user 112 comprises a moving visual object (e.g., a moving bar), a corresponding instruction to the user 112 can instruct the user 112 to move a body part (e.g., move index finger) in the same rhythm as the moving visual object. As another example, if a time-varying pattern presented to the user 112 comprises a flashing visual object (e.g., a flashing circle), a corresponding instruction to the user 112 can instruct the user 112 to move a body part (e.g., nod head) when the visual object lights up. As another example, if a time-varying pattern presented to the user 112 comprises a rhythmic audio beat, a corresponding instruction to the user 112 can instruct the user 112 to move a body part (e.g., raise eyebrows) on each beat.. As another example, if a time-varying pattern presented to the user 112 comprises a sequence of digits to be read aloud, a corresponding instruction to the user 112 can instruct the user 112 to read each digit aloud when it appears. As another example, if a time-varying pattern presented to the user 112 comprises an object (e.g., a letter, digit, word, symbol, shape, etc.) for the user 112 to draw or write in the air (i.e., virtual writing or air writing), a corresponding instruction to the user 112 can instruct the user 112 to move a finger to write or draw in the air the object. As another example, if a time-varying pattern presented to the user 112 comprises a visual cue with a curve, motion path, outline, or shape for the user 112 to draw, trace, or follow in the air (i.e., virtual writing or air writing), a corresponding instruction to the user 112 can instruct the user 112 to move a finger to draw, trace, or follow in the air the curve, motion path, outline, or shape. An instruction to the user 112 can be presented to the user 112 via the display 104 and/or the one or more audio speakers 110.

In some aspects, the instruction to the user 112 may require the user 112 to perform an additional user action, such as requiring the user 112 to move at least one of a physical object (e.g., a pen or another physical object within proximity of the user 112) or at least one hand of the user 112 across a virtual line positioned between a camera (e.g., camera 106) and a face or a body region of the user 112. Such physical movement helps disrupt deepfake software applications that lock onto (i.e., capture) a face of a user, preventing such applications from reliably locking onto or viewing the user's face (i.e., the physical movement obstructs the user's face) which, in turn, potentially causes such applications to produce glitches that the user presence verification system 120 can later flag as suspicious.

In some aspects, a time-varying pattern presented to the user 112 is visible to both the first camera 106 and the second camera 172, such that the pattern is visible in video data streams captured by the cameras 106 and 172. As the cameras 106 and 172 are positioned at different positions, the pattern's appearance in a video data stream captured by the first camera 106 may differ from the pattern's appearance in a video data stream captured by the second camera 172.

Each time-varying pattern includes explicit timing information, such as timestamps of audio peaks, audio beat intervals, audio phases, audio waveforms, etc. In some aspects, a specification for a synchronized action challenge includes a corresponding selected user action type, one or more parameters of a corresponding time-varying pattern, text of a corresponding instruction to the user 112, one or more expected user response characteristics, etc. A specification for a synchronized action challenge can be stored in a database 164 (e.g., specification database).

In some aspects, the user presence verification system 120 includes a prompt module 134 configured to present a synchronized action challenge to the user 112. Specifically, the prompt module 134 is configured to: (1) render a corresponding time-varying pattern on the display 104 and/or playback the pattern via the one or more audio speakers 110, (2) simultaneously present a corresponding instruction to the user 112 as text, graphics, and/or synthesized speech, and (3) define and record a temporal window corresponding to the challenge (i.e., challenge time window). The corresponding challenge time window can begin from when the pattern starts (i.e., a first audio/video frame of the pattern). The corresponding challenge time window can end at substantially about when the pattern ends (i.e., a last audio/video frame of the pattern), with an optional short offset.

Throughout the challenge time window, the user presence verification system 120 continues to obtain video frames of the user 112 via the camera 106. If the corresponding instruction to the user 112 requests that the user 112 verbally speak, the user presence verification system 120 obtains audio frames/samples of the user 112 in parallel via the microphone 108. User responses from the user 112 captured (e.g., via the camera 106 and, optionally, the microphone 108) during the challenge time window are to be evaluated.

To associate a captured data stream with a particular synchronized action challenge, each data stream captured (e.g., audio data stream captured via the microphone 108, video data stream(s) captured via the camera 106 and/or camera 172) during a synchronized action challenge presented to the user 112 is tagged with an identifier and a challenge time window corresponding to the synchronized action challenge.

In some aspects, the user presence verification system 120 includes a tracking module 138 configured for motion feature extraction. Specifically, utilizing one or more machine learning models 150, the tracking module 138 is configured to: (1) detect and track, within video data stream(s) of the user 112, one or more body regions required to perform a user action type corresponding to a synchronized action challenge, and (2) for each tracked body region, extract a corresponding motion time series. The tracking module 138 can utilize at least one of the following machine learning models 150: a head pose estimation model for detecting and tracking nodding/shaking, a facial landmark tracking model for detecting and tracking eyebrow movement, or a hand tracking model for detecting and tracking finger motions.

The tracking module 138 is optionally configured for audio feature extraction for speech-based synchronized action challenges (i.e., challenges requesting the user 112 to verbally speak). Specifically, utilizing the one or more machine learning models 150, the tracking module 138 is configured to: (1) detect and track, within an audio data stream of the user 112, one or more relevant audio events (e.g., e.g. onsets of spoken digits or syllables, amplitude peaks), and (2) for each tracked audio event, extract a corresponding audio time series. For example, the user presence verification system 120 can determine whether amplitude peaks are synchronized with expected beats.

In some aspects, the user presence verification system 120 includes a signal generator 140. For each audio/motion time series extracted via the tracking module 138, the signal generator 140 is configured to normalize and align the time series to a challenge time window corresponding to a synchronized action challenge, thereby generating one or more user response signals corresponding to one or more users actions (e.g., physical actions, speech actions) of the user 112. As described in detail later herein, user response signals are compared against a time-varying pattern corresponding to the challenge.

In some aspects, the user presence verification system 120 includes a synchrony evaluation module 142 configured to evaluate one or more user responses from the user 112 captured (e.g., via the camera 106 and, optionally, the microphone 108) during a challenge time window corresponding to a synchronized action challenge. Specifically, the synchrony evaluation module 142 is configured to retrieve a specification for a synchronized action challenge presented to the user 112 (e.g., from the database 164). The specification retrieved includes one or more parameters of a time-varying pattern corresponding to the challenge, such as expected motion path of a moving visual object, one or more event timings, one or more allowable delays and/or tolerances, etc.

The synchrony evaluation module 142 is configured to compute one or more spatial correctness measurements (i.e., scores) representing spatial correctness (i.e., spatial correspondence) between one or more user response signals (e.g., from the signal generator 140) and the time-varying pattern, based on the one or more parameters of the pattern. If a selected user action type corresponding to the challenge comprises a motion action, the synchrony evaluation module 142 evaluates whether a direction, an amplitude, and a general shape of a user movement of the user 112 matches an expected motion path (e.g., correct up-down vs. left-right orientation, movement occurring along a correct axis, etc.). If a selected user action type corresponding to the challenge comprises a speech action, the synchrony evaluation module 142 evaluates correctness of a sequence of digits or syllables verbally spoken by the user 112 (e.g., whether the sequence matches a sequence of digits or syllables presented via the display 104 and/or the one or more audio speakers 110).

The synchrony evaluation module 142 is configured to compute one or more temporal alignment measurements (i.e., scores) representing temporal alignment (i.e., temporal correspondence) between one or more user response signals (e.g., from the signal generator 140) and the time-varying pattern, based on the one or more parameters of the pattern. Specifically, the synchrony evaluation module 142 is configured to: (1) compute one or more quantitative measures of temporal synchrony between the pattern and the one or more user response signals, and (2) derive one or more latency metrics characterizing how quickly one or more user actions of the user 112 follow one or more audio and/or visual cues of the pattern. Examples of quantitative measures of temporal synchrony include, but are not limited to, a correlation coefficient between expected and observed waveforms, a phase difference, a per-event delay, periodicity comparison, etc.

In some aspects, for each spatial correctness/temporal alignment measurement computed, the synchrony evaluation module 142 is configured to perform a comparison between the measurement and a corresponding pre-defined or learned threshold. Based on each comparison performed, the synchrony evaluation module 142 is configured to generate, as output, a challenge result for the challenge, where the challenge result indicates whether the user 112 successfully completed the challenge. In one aspects, a challenge results comprises at least one of a binary pass/fail decision, a confidence score indicative of a degree of likelihood the user 112 is a live person participating in the online session and following an instruction corresponding to the challenge. In some aspects, the synchrony evaluation module 142 is configured to utilize a machine learning model (e.g., a machine learning model 150) to classify the one or more user response signals as valid (i.e., a valid human response) or suspicious based on extracted audio and/or motion features, such as delay distribution, smoothness of motion, and pattern of micro-movements. If the one or more user response signals are classified as suspicious or at least one of the measurements computed exceeds a corresponding threshold, the challenge result can include one or more flags indicating probable categories of attack (e.g., suspected deepfake overlay, pre-recorded video, remote human who is different from the user 112 and is relaying instructions and/or participating in the online session, etc.).

In some aspects, the user presence verification system 120 includes a decision module 144 configured to make a decision based on a challenge result for a synchronized action challenge (e.g., from the synchrony evaluation module 142). In some aspects, the decision module 144 maintains an internal trust or risk score for the online session, and updates the score based on the challenge result. If the user 112 successfully passed the challenge with a sufficient confidence score, the decision module 144 records this as a successful liveness verification, and continues the online session (e.g., continues the online examination or other online interaction with the user 112). If the user 112 failed the challenge or one or more user response signals are flagged as suspicious (e.g., the challenge result includes one or more flags indicating probable categories of attack), the decision module 144 is configured to perform at least one of the following actions: trigger one or more additional and different synchronized action challenges (e.g., other user action types requiring other body parts, different time-varying patterns); escalate to a human proctor for manual review; mark the online session as potentially suspicious (e.g., cheating is suspected) and store evidence; or terminate or invalidate the online session (e.g., terminate or invalidate the online examination).

In some aspects, the decision module 144 can aggregate multiple challenge results for multiple synchronized action challenges over the course of the online session into a final decision (e.g., using weighted averaging or voting over the challenge results).

In some aspects, the user presence verification system 120 optionally includes an alert module 146 configured to generate and transmit an alert. In one non-limiting example aspect, the alert module 146 is configured to generate and transmitting an alert to a human proctor if the user 112 failed a synchronized action challenge or one or more user response signals are flagged as suspicious.

In some aspects, the user presence verification system 120 optionally includes a training module 148 and a training database 166 including one or more sets of training data. The training module 148 is configured to train or update (e.g., finetune) at least one of the machine learning models 150 based on at least one set of training data from the training database 166.

In some aspects, the user presence verification system 120 is configured to run on a standard end user device or consumer device, such as the computing device 102. In some aspects, the user presence verification system 120 is compatible with both web-based and native application environments. In some aspects, the user presence verification system 120 requires no specialized hardware components or resources, and can utilize standard hardware resources (e.g., a central processing unit (CPU), a graphical processing unit (GPU), and/or a memory) already available in standard end user devices or consumer devices. In some aspects, the user presence verification system 120 can be deployed on cloud servers for enterprise-scale application scenarios.

In some aspects, the user presence verification system 120 is integrated into, or implemented as part of, educational and training platforms.

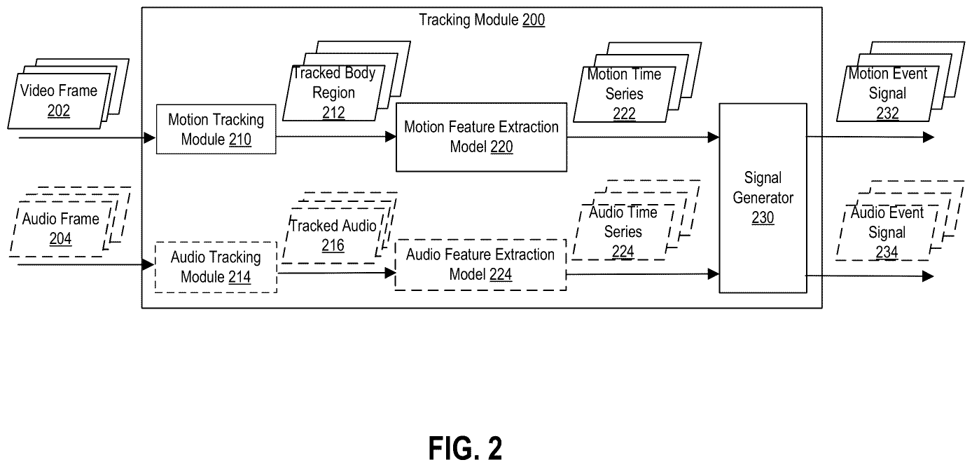

FIG. 2 is a block diagram of an example tracking module 200, according to some aspects of the present disclosure. In some aspects, the tracking module 138 in FIG. 1 is implemented as the tracking module 200.

In some aspects, the tracking module 200 includes a motion tracking module 210 configured to: (1) obtain video data stream(s) (e.g., captured by the camera 106 and/or camera 172 in FIG. 1) comprising one or more video frames 202 of a user 112 (FIG. 1), and (2) based on the one or more video frames 202, detect and track one or more body regions required to perform a user action type corresponding to a synchronized action challenge.

In some aspects, the tracking module 200 includes a motion feature extraction model 220. The model 220 is a machine learning model. For each body region detected and tracked via the motion tracking module 210, the model 220 is configured to extract a corresponding motion time series.

In some aspects, the tracking module 200 optionally includes an audio tracking module 214 configured to: (1) obtain an audio data stream (e.g., captured by the microphone 108 in FIG. 1) comprising one or more audio frames/samples 204 of the user 112 (FIG. 1), and (2) based on the one or more audio frames/samples 204, detect and track one or more relevant audio events (e.g., e.g. onsets of spoken digits or syllables, amplitude peaks).

In some aspects, the tracking module 200 optionally includes an audio feature extraction model 224. The model 224 is a machine learning model. For each relevant audio event detected and tracked via the audio tracking module 214, the model 224 is configured to extract a corresponding audio time series.

In some aspects, a signal generator 230 is coupled to, or integrated in, the tracking module 200. In some aspects, the signal generator 140 in FIG. 1 is implemented as the signal generator 230. For each motion time series extracted via the model 220, the signal generator 230 is configured to: (1) normalize and align the time series to a challenge time window corresponding to the synchronized action challenge, and (2) generate, based on the normalized and aligned time series, one or more motion event signals 232, where the one or more motion event signals 232 are one or more user response signals corresponding to one or more physical actions of the user 112.

Optionally, for each audio time series extracted via the model 224, the signal generator 230 is configured to: (1) normalize and align the time series to a challenge time window corresponding to the synchronized action challenge, and (2) generate, based on the normalized and aligned time series, one or more audio event signals 234, where the one or more audio event signals 234 are one or more user response signals corresponding to one or more speech actions of the user 112.

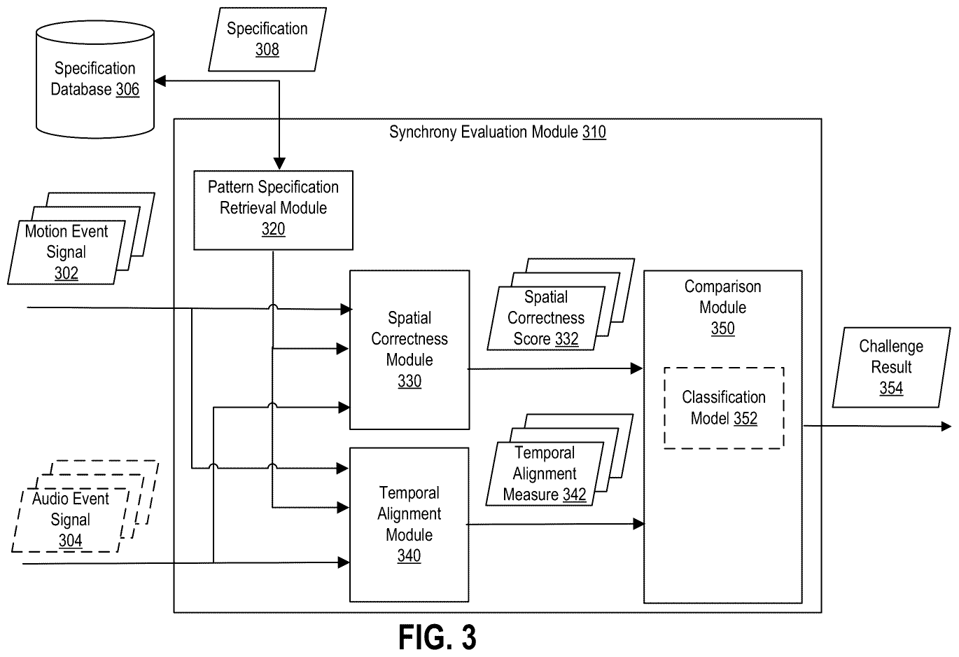

FIG. 3 is a block diagram of an example synchrony evaluation module 310, according to some aspects of the present disclosure. In some aspects, the synchrony evaluation module 142 in FIG. 1 is implemented as the synchrony evaluation module 310.

In some aspects, the synchrony evaluation module 310 includes a pattern specification retrieval module 320 configured to retrieve a specification 308 for a synchronized action challenge presented to the user 112 (e.g., from specification database 306 in FIG. 3 or pattern specification database 164 in FIG. 1). The specification 308 includes one or more parameters of a time-varying pattern corresponding to the challenge, such as expected motion path of a moving visual object, one or more event timings, one or more allowable delays and/or tolerances, etc.

In some aspects, the synchrony evaluation module 310 includes a spatial correctness module 330 configured to receive the specification 308 (e.g., from pattern specification retrieval module 320), one or more motion event signals 302 (e.g., from signal generator 230 in FIG. 2 or signal generator 140 in FIG. 1), and, optionally, one or more audio event signals 304 (e.g., from signal generator 230 in FIG. 2 or signal generator 140 in FIG. 1). The spatial correctness module 330 is configured to compute, based on the one or more parameters of the pattern that are included in the specification 308, one or more spatial correctness measurements/scores 332 representing spatial correctness (i.e., spatial correspondence) between the time-varying pattern and the one or more motion event signals 302 (and, optionally, the one or more audio event signals 304).

In some aspects, the synchrony evaluation module 310 includes a temporal alignment module 340 configured to receive the specification 308 (e.g., from pattern specification retrieval module 320), the one or more motion event signals 302 (e.g., from signal generator 230 in FIG. 2 or signal generator 140 in FIG. 1), and, optionally, the one or more audio event signals 304 (e.g., from signal generator 230 in FIG. 2 or signal generator 140 in FIG. 1). The temporal alignment module 340 is configured to compute, based on the one or more parameters of the pattern that are included in the specification 308, one or more temporal alignment measurements/scores 342 representing temporal alignment (i.e., temporal correspondence) between the time-varying pattern and the one or more motion event signals 302 (and, optionally, the one or more audio event signals 304). The one or more temporal alignment measurements/scores 342 include one or more quantitative measures of temporal synchrony between the pattern and the one or more motion event signals 302 (and, optionally, the one or more audio event signals 304), and one or more latency metrics characterizing how quickly one or more user actions of the user 112 follow one or more audio and/or visual cues of the pattern.

In some aspects, the synchrony evaluation module 310 includes a comparison module 350 configured to receive the one or more spatial correctness measurements/scores 332 (e.g., from spatial correctness module 330) and the one or more temporal alignment measurements/scores 342 (e.g., from temporal alignment module 340). For each measurement/score 332/342 received, the comparison module 350 is configured to perform a comparison between the measurement/score 332/342 and a corresponding pre-defined or learned threshold. Based on each comparison performed, the comparison module 350 is configured to generate, as output, a challenge result 354 for the challenge, where the challenge result indicates whether the user 112 successfully completed the challenge.

In some aspects, the comparison module 350 optionally utilizes a classification model 352 to classify the one or more motion event signals 302 (and, optionally, the one or more audio event signals 304) as valid (i.e., a valid human response) or suspicious based on extracted audio and/or motion features, such as delay distribution, smoothness of motion, and pattern of micro-movements. In some aspects, the classification model 352 is a machine learning model. If the one or more motion event signals 302 (and, optionally, the one or more audio event signals 304) are classified as suspicious or at least one of the measurements/scores 332/342 received exceeds a corresponding threshold, the challenge result 354 can include one or more flags indicating probable categories of attack (e.g., suspected deepfake overlay, pre-recorded video, remote human who is different from the user 112 and is relaying instructions and/or participating in the online session, etc.).

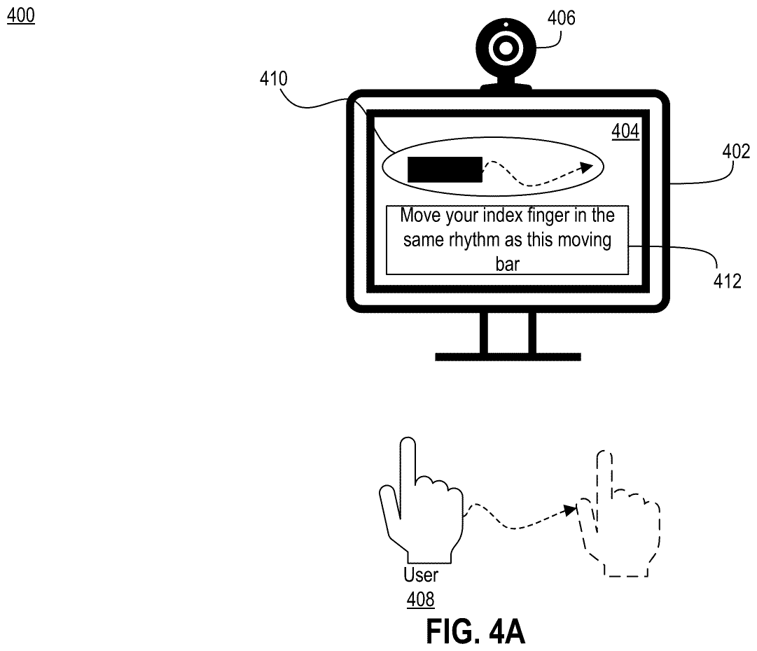

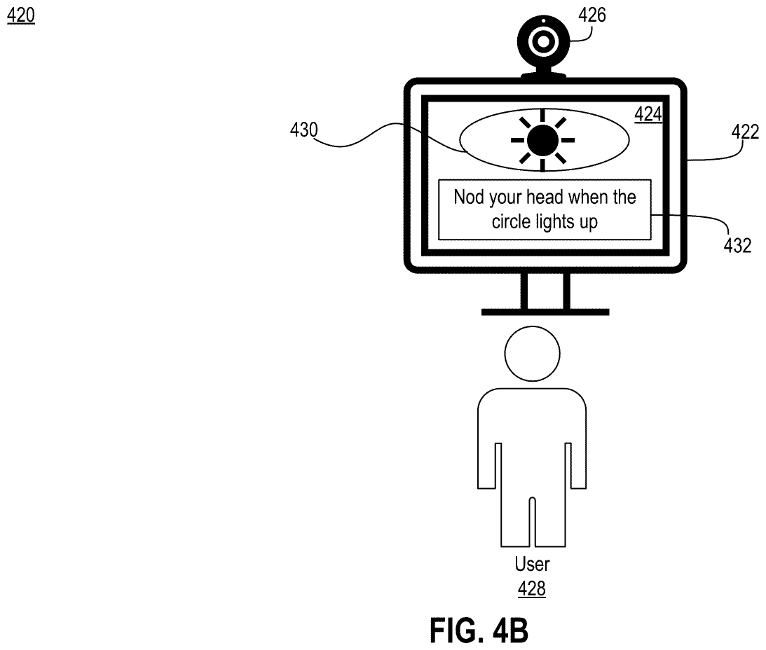

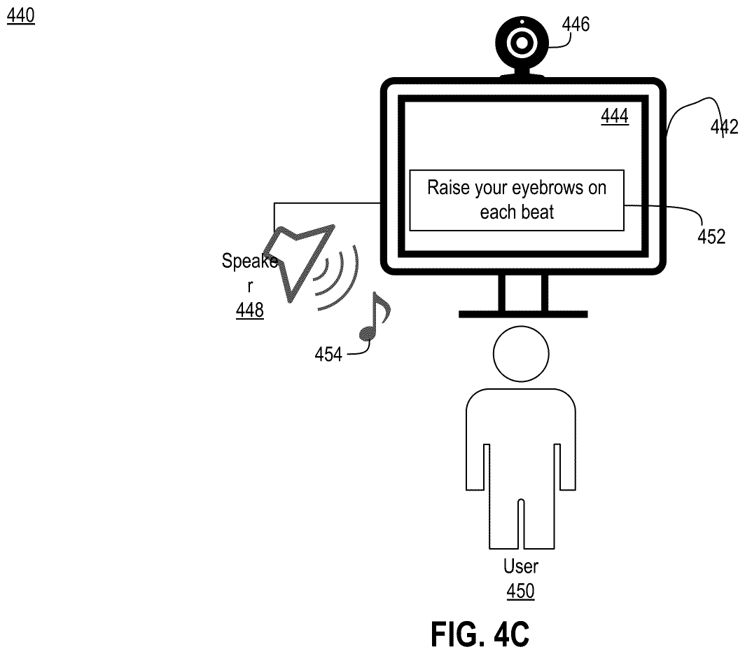

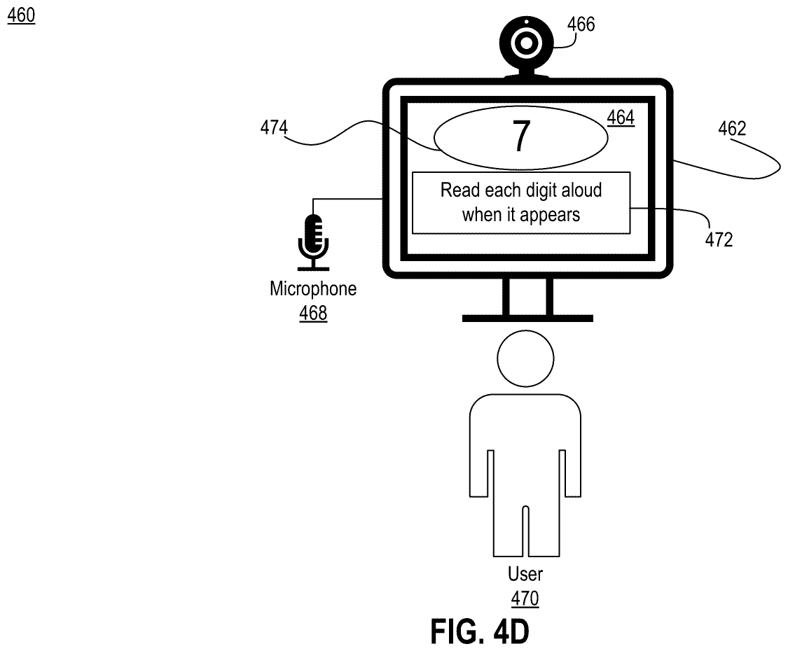

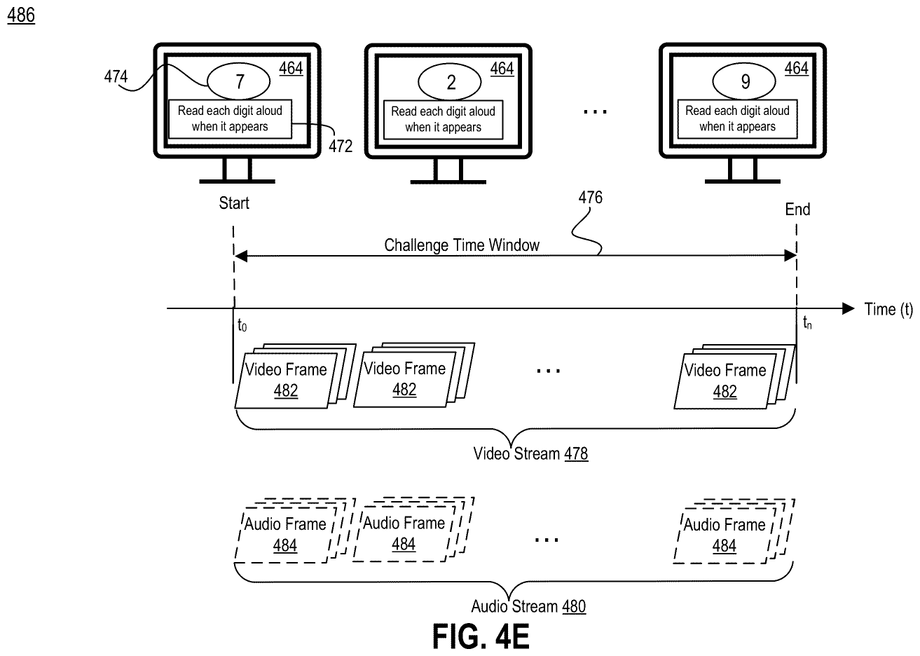

FIG. 4A is a first example synchronized action challenge 400, according to some aspects of the present disclosure. In some aspects, the challenge generator 132 (FIG. 1) generates, for the synchronized action challenge 400, a corresponding time-varying pattern including a visual cue 410, where the visual cue 410 comprises a moving visual object (e.g., a moving bar) following a motion path. The challenge generator 132 further generates, for the synchronized action challenge 400, a corresponding instruction 412 to a user 408 (e.g., user 112 in FIG. 1) based on the visual cue 410, where the instruction 412 instructs the user 408 to move their index finger in the same rhythm as the moving visual object. The challenge generator 132 then triggers the prompt module 134 (FIG. 1) to simultaneously display, to the user 408, the visual cue 410 and the instruction 412 on a display 404 (e.g., display 104 in FIG. 1) of a computing device 402 (e.g., computing device 102 in FIG. 1). The tracking module 138 (FIG. 1) or 200 (FIG. 2) utilizes a hand tracking model (e.g., machine learning model 150 in FIG. 1) for detecting and tracking, within a video data stream captured by a camera 406 (e.g., camera 106 in FIG. 1) one or more finger motions of the user 408.

FIG. 4B is a second example synchronized action challenge 420, according to some aspects of the present disclosure. In some aspects, the challenge generator 132 (FIG. 1) generates, for the synchronized action challenge 420, a corresponding time-varying pattern including a visual cue 430, where the visual cue 430 comprises a flashing visual object (e.g., a flashing circle) that changes state at discrete time instants. The challenge generator 132 further generates, for the synchronized action challenge 420, a corresponding instruction 432 to a user 428 (e.g., user 112 in FIG. 1) based on the visual cue 430, where the instruction 432 instructs the user 428 to nod their head when the visual object flashes or lights up. The challenge generator 132 then triggers the prompt module 134 (FIG. 1) to simultaneously display, to the user 428, the visual cue 430 and the instruction 432 on a display 424 (e.g., display 104 in FIG. 1) of a computing device 422 (e.g., computing device 102 in FIG. 1). The tracking module 138 (FIG. 1) or 200 (FIG. 2) utilizes a head pose estimation model (e.g., machine learning model 150 in FIG. 1) for detecting and tracking, within a video data stream captured by a camera 426 (e.g., camera 106 in FIG. 1) head nodding/shaking of the user 428.

FIG. 4C is a third example synchronized action challenge 440, according to some aspects of the present disclosure. In some aspects, the challenge generator 132 (FIG. 1) generates, for the synchronized action challenge 440, a corresponding time-varying pattern including an audio cue 454, where the audio cue 454 comprises a rhythmic audio beat. The challenge generator 132 further generates, for the synchronized action challenge 440, a corresponding instruction 452 to a user 458 (e.g., user 112 in FIG. 1) based on the audio cue 454, where the instruction 452 instructs the user 458 to raise their eyebrows on each beat. The challenge generator 132 then triggers the prompt module 134 (FIG. 1) to simultaneously: (1) playback, to the user 458, the audio cue 454 via one or more audio speakers 448 (e.g., audio speakers 110 in FIG. 1), and (2) display, to the user 458, the instruction 452 on a display 444 (e.g., display 104 in FIG. 1) of a computing device 442 (e.g., computing device 102 in FIG. 1). The tracking module 138 (FIG. 1) or 200 (FIG. 2) utilizes a facial landmark tracking model(e.g., machine learning model 150 in FIG. 1) for detecting and tracking, within a video data stream captured by a camera 446 (e.g., camera 106 in FIG. 1) eyebrow movement of the user 458.

FIG. 4D is a fourth example synchronized action challenge 460, according to some aspects of the present disclosure. In some aspects, the challenge generator 132 (FIG. 1) generates, for the synchronized action challenge 460, a corresponding time-varying pattern including a visual cue 474, where the visual cue 430 comprises a sequence of digits to be presented to a user 470 (e.g., user 112 in FIG. 1) one at a time. The challenge generator 132 further generates, for the synchronized action challenge 460, a corresponding instruction 472 to the user 470 based on the visual cue 474, where the instruction 472 instructs the user 470 to read each digit of the sequence aloud when the digit is presented. The challenge generator 132 then triggers the prompt module 134 (FIG. 1) to simultaneously display, to the user 428, the visual cue 474 and the instruction 472 on a display 464 (e.g., display 104 in FIG. 1) of a computing device 462 (e.g., computing device 102 in FIG. 1).

FIG. 4E is an example workflow 486 for tracking user actions of the user 470 in response to the fourth example synchronized action challenge 460, according to some aspects of the present disclosure. The tracking module 138 (FIG. 1) or 200 (FIG. 2) utilizes one or more machine learning models (e.g., machine learning model 150 in FIG. 1) for detecting and tracking, within one or more audio frames/samples 484 of an audio data stream 480 captured by a microphone 468 (e.g., microphone 108 in FIG. 1) and one or more video frames 482 of a video data stream 478 captured by a camera 466 (e.g., camera 106 in FIG. 1), each onset of each digit spoken by the user 470 (e.g., spoken digits 7, 2, . . . , and 9) during a challenge time window 476 corresponding to the challenge 460. In some aspects, the challenge time window 476 begins at about time t₀ (e.g., when a first digit of the sequence is presented), and the challenge time window 476 ends at about time tₙ (e.g., when a last digit of the sequence is presented and optionally, plus some offset).

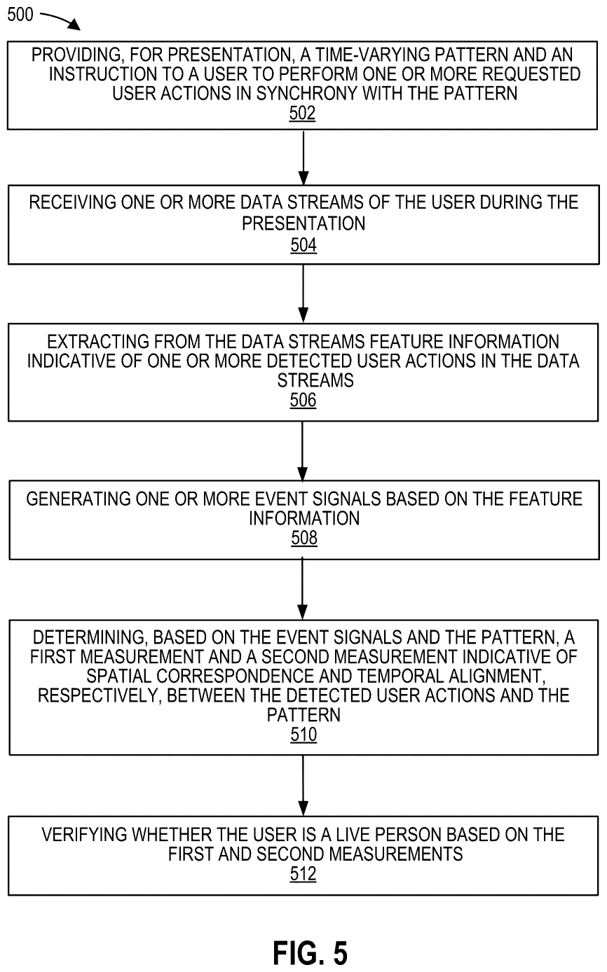

FIG. 5 is flow diagram of an example method 500 for verifying live user presence in an online session, according to some aspects of the present disclosure. At block 502, the method 500 includes providing, for presentation, a time-varying pattern and an instruction to a user to perform one or more requested user actions in synchrony with the pattern.

At block 504, the method 500 includes receiving one or more data streams of the user during the presentation.

At block 506, the method 500 includes extracting from the data streams feature information indicative of one or more detected user actions in the data streams.

At block 508, the method 500 includes generating one or more event signals based on the feature information.

At block 510, the method 500 includes determining, based on the event signals and the pattern, a first measurement and a second measurement indicative of spatial correspondence and temporal alignment, respectively, between the detected user actions and the pattern.

At block 512, the method 500 includes verifying whether the user is a live person based on the first and second measurements.

In some aspects, blocks 502-512 of the method 500 can be performed by one or more components of the user presence verification system 120 (FIG. 1), the tracking module 200 (FIG. 2), and/or the synchrony evaluation module 310 (FIG. 3).

Aspects of the present disclosures, such as the user presence verification system 120 (FIG. 1), the tracking module 200 (FIG. 2), and/or the synchrony evaluation module 310 (FIG. 3), can be implemented using hardware, software, or a combination thereof and can be implemented in one or more computer systems or other processing systems. In an aspect of the present disclosures, features are directed toward one or more computer systems capable of carrying out the functionality described herein. An example of such a computer system 20 is shown in FIG. 6. The user presence verification system 120 (FIG. 1), the tracking module 200 (FIG. 2), and/or the synchrony evaluation module 310 (FIG. 3) can include some or all of the components of the computer system 20.

FIG. 6 is a block diagram illustrating the computer system 20 on which aspects of systems and methods for AI-driven visual cues (e.g., markers, pointers, highlights, etc.) for contextual navigation within graphical user interfaces may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include aw single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for verifying live user presence in an online session, comprising:
providing, for presentation, a time-varying pattern and an instruction to a user to perform one or more requested user actions in synchrony with the pattern;
receiving one or more data streams of the user during the presentation;
extracting from the data streams feature information indicative of one or more detected user actions in the data streams;
generating one or more event signals based on the feature information;
determining, based on the event signals and the pattern, a first measurement and a second measurement indicative of spatial correspondence and temporal alignment, respectively, between the detected user actions and the pattern; and
verifying whether the user is a live person based on the first and second measurements.

2. The method of claim 1, wherein each user action comprises at least one of a physical action or a speech action.

3. The method of claim 1, wherein the pattern comprises at least one of a time-varying visual cue presented via a display or a time-varying audio cue presented via one or more audio speakers.

4. The method of claim 1, wherein the data streams comprise at least one of a video data stream or an audio data stream.

5. The method of claim 4, further comprising:
detecting, in one or more individual video frames of the video data stream, at least one body region of the user corresponding to a physical action; and
tracking a position or an orientation of the at least one body region over time;
wherein the feature information comprises a motion time series of the position, the orientation, or a derivative thereof.

6. The method of claim 4, further comprising:
detecting, in one or more individual audio frames of the audio data stream, at least one utterance spoken by the user;
wherein the feature information comprises an audio motion time series of the at least one utterance.

7. The method of claim 1, wherein the verifying comprises:
determining whether the first and second measurements satisfy pre-determined criteria; and
determining the detected user actions are suspicious in response to determining the first and second measurements do not satisfy the pre-determined criteria.

8. The method of claim 1, wherein the verifying comprises:
classifying, using a machine learning model, the detected user actions as valid or suspicious.

9. The method of claim 1, further comprising:
randomly selecting an action type from a plurality of different action types, wherein the plurality of different action types comprise at least one of a head movement, a hand movement, a finger movement, an eyebrow movement, or a reading of one or more words and/or one or more numbers; and
generating the pattern based on the selected action type.

10. The method of claim 1, further comprising:
repeating at least one of the providing, the receiving, the extracting, the generating, the determining, or the verifying for different time-varying patterns and different instructions during the online session; and
determining an overall trust score for the user based on an aggregate of each measurement determined.

11. The method of claim 1, wherein the instruction is presented via at least one of a display or one or more audio speakers.

12. The method of claim 1, wherein the instruction further requires the user to move at least one of a physical object or at least one hand of the user across a virtual line positioned between a camera capturing a video data stream of the user and a face or a body region of the user.

13. The method of claim 1, wherein the data streams comprise at least one of a first video data stream captured by a first camera, a second video data stream captured by a second camera, or a sensor data stream captured by a sensor, and wherein the first camera and the second camera are positioned at different positions relative to the user.

14. A system for verifying live user presence in an online session, comprising:
one or more memories configured to store executable instructions; and
one or more processors communicatively coupled with the one or more memories and configured, individually or in any combination, to execute the executable instructions to:
provide, for presentation, a time-varying pattern and an instruction to a user to perform one or more requested user actions in synchrony with the pattern;
receiving one or more data streams of the user during the presentation;
extract from the data streams feature information indicative of one or more detected user actions in the data streams;
generate one or more event signals based on the feature information;
determine, based on the event signals and the pattern, a first measurement and a second measurement indicative of spatial correspondence and temporal alignment, respectively, between the detected user actions and the pattern; and
verify whether the user is a live person based on the first and second measurements.

15. The system of claim 14, wherein each user action comprises at least one of a physical action or a speech action.

16. The system of claim 14, wherein the pattern comprises at least one of a time-varying visual cue presented via a display or a time-varying audio cue presented via one or more audio speakers.

17. The system of claim 14, wherein the data streams comprise at least one of a video data stream or an audio data stream.

18. The system of claim 17, wherein the one or more processors are further configured, individually or in any combination, to:
detect, in one or more individual video frames of the video data stream, at least one body region of the user corresponding to a physical action; and
track a position or an orientation of the at least one body region over time;
wherein the feature information comprises a motion time series of the position, the orientation, or a derivative thereof.

19. The system of claim 17, wherein the one or more processors are further configured, individually or in any combination, to:
detect, in one or more individual audio frames of the audio data stream, at least one utterance spoken by the user;
wherein the feature information comprises an audio motion time series of the at least one utterance.

20. A non-transitory computer-readable medium having instructions for verifying live user presence in an online session, the instructions are executable by one or more processors, individually or in any combination, to:
provide, for presentation, a time-varying pattern and an instruction to a user to perform one or more requested user actions in synchrony with the pattern;
receive one or more data streams of the user during the presentation;
extract from the data streams feature information indicative of one or more detected user actions in the data streams;
generate one or more event signals based on the feature information;
determine, based on the event signals and the pattern, a first measurement and a second measurement indicative of spatial correspondence and temporal alignment, respectively, between the detected user actions and the pattern; and
verify whether the user is a live person based on the first and second measurements.
